(19) United States
(12) Patent Application Publication
(10) Pub. No.: US 2023/0302877 A1
(43) Pub. Date: Sep. 28, 2023

(54) SELF-CONTAINED HVAC SYSTEM FOR VEHICLES AND METHOD OF USE THEREOF

(71) Applicant: Simplicity Air Ltd., Hagersville (CA)

(72) Inventor: Brian BASSINDALE, Hagersville (CA)

(73) Assignee: Simplicity Air Ltd., Hagersville (CA)

(21) Appl. No.: 18/191,064

(22) Filed: Mar. 28, 2023

Related U.S. Application Data
(60) Provisional application No. 63/324,368, filed on Mar. 28, 2022.

(30) Foreign Application Priority Data
Mar. 27, 2023 (CA) 3.194.202

(51) Int. Cl. B60H 1/00; B60H 1/32

(52) U.S. Cl. CPC B60H 1/3229; B60H 1/00464

(57) ABSTRACT

There is provided an HVAC system and method of use thereof for operation with a vehicle, the HVAC system comprising: a frame having a front portion and a rear portion, one or more manually releasable clamps configured to releasably couple the frame to a chassis of the vehicle, and system components secured to the frame. The system components include an evaporator and a blower secured to the rear portion of the frame, and a condenser, a compressor, and a receiver drier secured to the front portion of the frame. The condenser, the compressor, and the evaporator are operatively coupled together in fluid communication, and one or more condenser fans are secured to the front portion of the frame in operational engagement with the condenser.

### FIELD

This invention relates generally to HVAC systems and methods, and in particular, to releasable single-unit HVAC systems for use with electric vehicles.

### BACKGROUND

The global need to electrify vehicles has further increased the need and desire for energy efficient, long lasting HVAC systems for vehicles that provide better air quality. In conjunction with efforts to reduce emissions in vehicles, reducing the emissions of refrigerants and improved utilization of energy is critical.

One example of a vehicle that requires an effective and efficient HVAC system is an ambulance, where not only must the occupants be kept warm or cooled depending on the ambient conditions, but also where adequate ventilation and/or air purification may be desired, or mandated. Such vehicles can be operated in northern climates that are exposed to freezing temperatures, or southern climates that are arid and very hot, thereby placing a potentially wide range of demands on their HVAC systems. Since ambulances are typically made from a cab and chassis with a patient compartment installed, and are manufactured for a number of different possible applications, their factory HVAC systems, while adequate for the cab itself, may not sufficient to acclimatize the interior of the patient compartment of the ambulance.

Furthermore, the typical ambulance HVAC system is usually a split system, which means a condenser is either chassis provided or additionally added to the vehicle exterior with no connection to the evaporator assembly directly. Additional hoses are then required to make those connections, which can provide room for error upon installation and may chafe on other components. This presents opportunity for refrigerant loss, which contributes to global warming.

The need for enhanced ventilation and/or air filtration has been elevated by the recent COVID-19 pandemic. Improved HVAC systems, over and above those commonly supplied with a vehicle when purchased from a manufacturer, can also be desirable for delivery trucks, buses, recreational vehicles, etc. The increasing popularity of electric vehicles has also placed greater burdens and new, previously unforeseen, obstacles on current HVAC systems, such as the requirement to reduce refrigerant emissions and to extend the life of components due to the cost.

### SUMMARY

In one aspect of the invention, there is provided an HVAC system for operation with a vehicle, the HVAC system comprising: a frame having a front portion and a rear portion; one or more manually releasable clamps configured to releasably couple the frame to a chassis of the vehicle; and system components secured to the frame, the system components comprising: an evaporator and a blower secured to the rear portion of the frame; a condenser, a compressor, and a receiver drier are secured to the front portion of the frame, wherein the condenser, the compressor, and the evaporator are operatively coupled together in fluid communication; and one or more condenser fans secured to the front portion of the frame in operational engagement with the condenser.

In another aspect of the invention, there is provided the above HVAC system wherein the front portion of the frame is larger than the rear portion of the frame.

In another aspect of the invention, there is provided the above HVAC system further comprising a chassis module secured to the frame, the chassis module further adapted to be securable to the chassis of the vehicle; the one or more manually releasable clamps configured to releasably secure the chassis module to the chassis of the vehicle.

In another aspect of the invention, there is provided a method of installing a single-unit HVAC system to a vehicle comprising: inserting a rear portion of the single-unit HVAC system through an opening in a wall of the vehicle; and releasably coupling the single-unit HVAC system to a chassis of the vehicle.

In another aspect of the invention, there is provided the above method further comprising securing a chassis module to a frame of the single-unit HVAC system; wherein releasably coupling the single-unit HVAC system to the chassis of the vehicle comprises releasably securing the chassis module to the chassis of the vehicle.

In a further aspect of the invention, there is provided a kit comprising: a single-unit HVAC system for operation with a vehicle; a chassis module adapted to be securable to the single-unit HVAC system and to a chassis of the vehicle,; and one or more manually releasable clamps configured to releasably couple the chassis module to the chassis of the vehicle.

In a further aspect of the invention, there is provided an HVAC system for operation with an electric vehicle, the HVAC system comprising: a frame having a front portion and a rear portion, where the front portion is wider than the rear portion; a chassis module secured to the frame, the chassis module adapted to be secured to a chassis of the electric vehicle; one or more manually releasable clamps configured to releasably secure the chassis module to the chassis of the electric vehicle; and system components secured to the frame, the system components comprising: an evaporator, a blower, and a heater secured to the rear portion of the frame; a condenser, a compressor, and a receiver drier are secured to the front portion of the frame, wherein the condenser, the compressor, and the evaporator are operatively coupled together in fluid communication; and one or more condenser fans secured to the front portion of the frame in operational engagement with the condenser; wherein the electric vehicle is an ambulance.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a rear perspective view of an HVAC system in isolation in accordance with an embodiment of the present invention;

FIG. 2 is a front view of the HVAC system of FIG. 1;

FIG. 3 is a left side view of the HVAC system of FIG. 1;

FIG. 4 is a rear view of the HVAC system of FIG. 1;

FIG. 5 is a right side view of the HVAC system of FIG. 1;

FIG. 6 is a plan view of the HVAC system of FIG. 1;

FIG. 7 is a bottom view of the HVAC system of FIG. 1;

FIG. 8 is a flowchart illustrating a method installing the HVAC system of FIG. 1 onto a vehicle;

FIG. 9 is a front perspective view of the HVAC system of FIG. 1 in use with a vehicle shown in part;

FIG. 10 is an enlarged view of portion A of FIG. 8;

FIG. 11 is a right-rear perspective view of the HVAC system of FIG. 8 with the vehicle shown in part;

FIG. 12 is a left-rear perspective view of the HVAC system of FIG. 8 with the vehicle shown in part;

FIG. 13 is a front view of the HVAC system of FIG. 8 with the vehicle shown in part;

FIG. 14 is an enlarged right side view of the HVAC system of FIG. 8 with the vehicle shown in part;

FIG. 15 is a rear view of the HVAC system of FIG. 8 with the vehicle shown in part;

FIG. 16 is a plan view of the HVAC system of FIG. 8 with the vehicle shown in part;

FIG. 17 is a schematic view of operating components of the HVAC system of FIG. 1 in use with an HVAC CAN system;

FIGS. 18, 19, and 20 comprise a flow chart detailing the operational parameters and control of the HVAC system of FIG. 1.

### DESCRIPTION

The present invention may be embodied in a number of different forms. The specification and drawings that follow describe and disclose some of the specific forms of the invention.

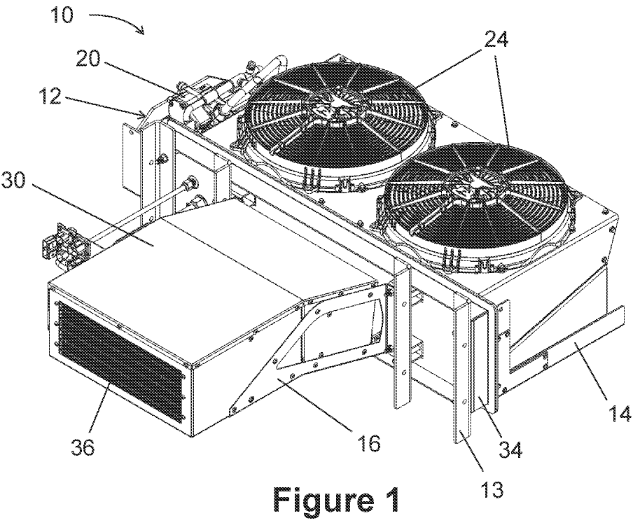

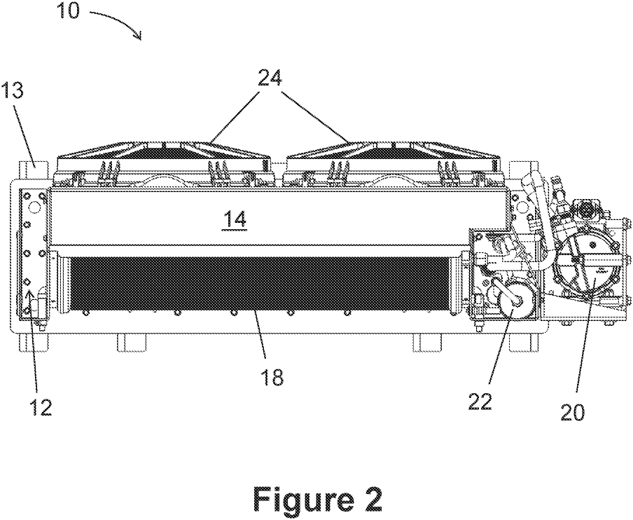

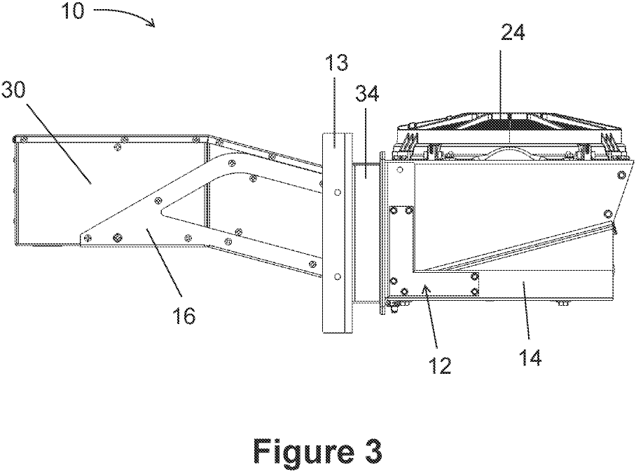

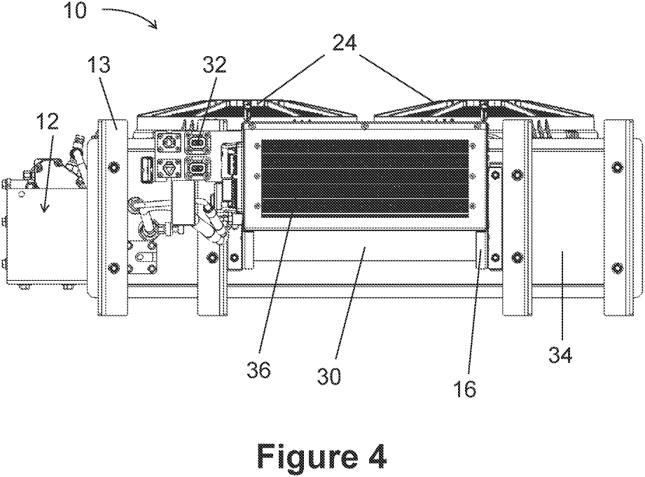

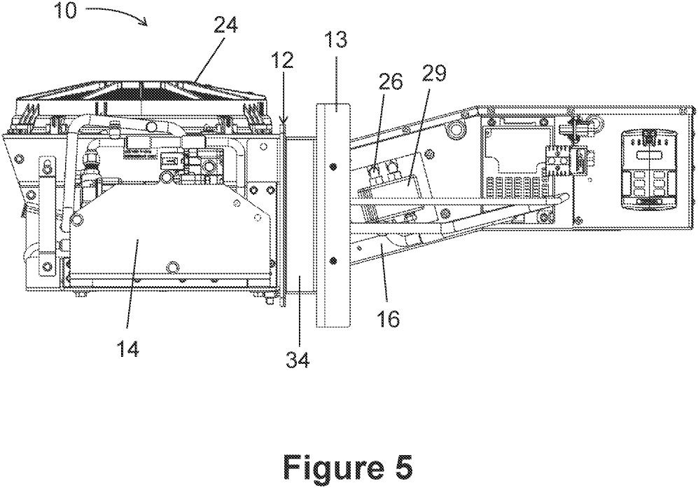

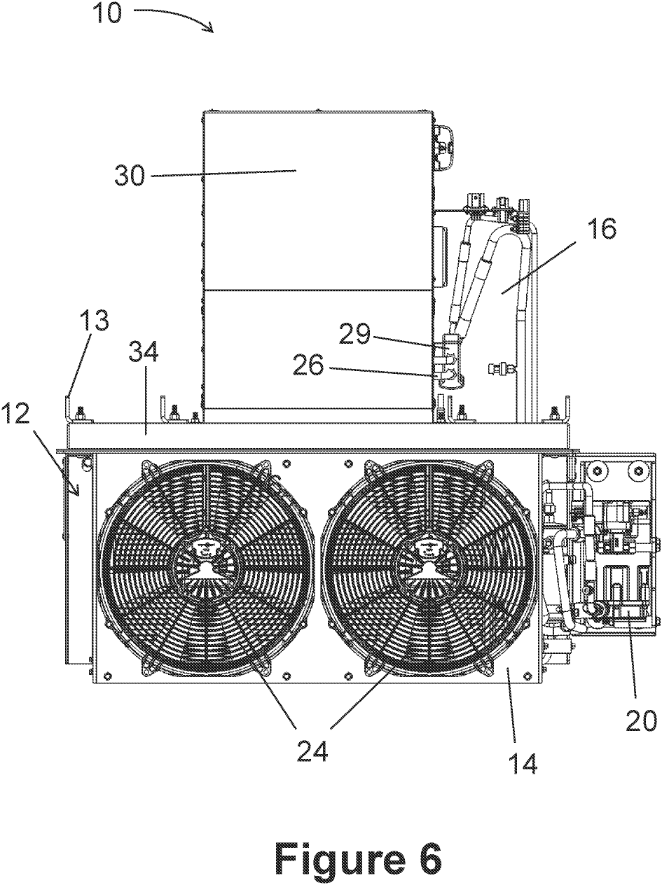

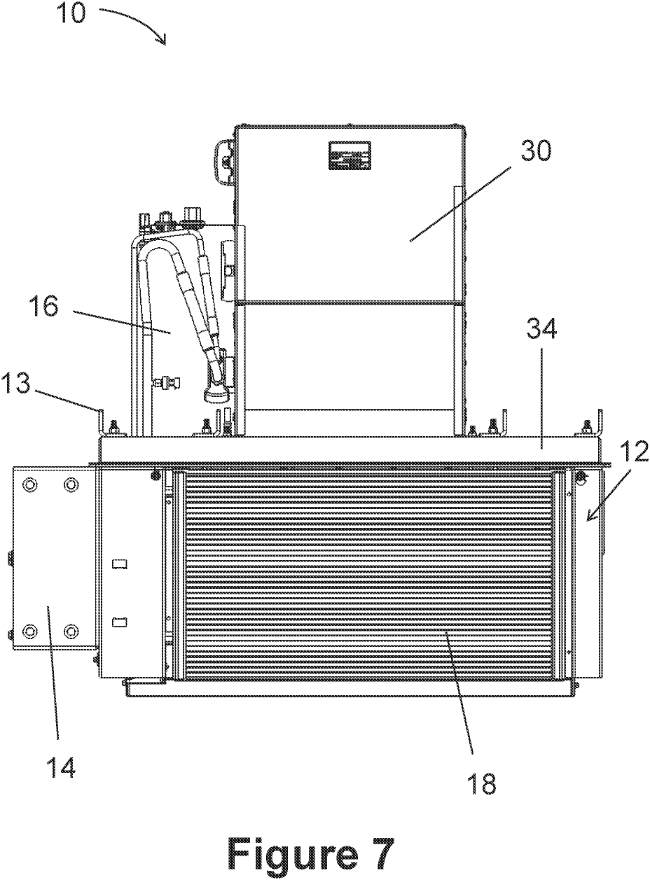

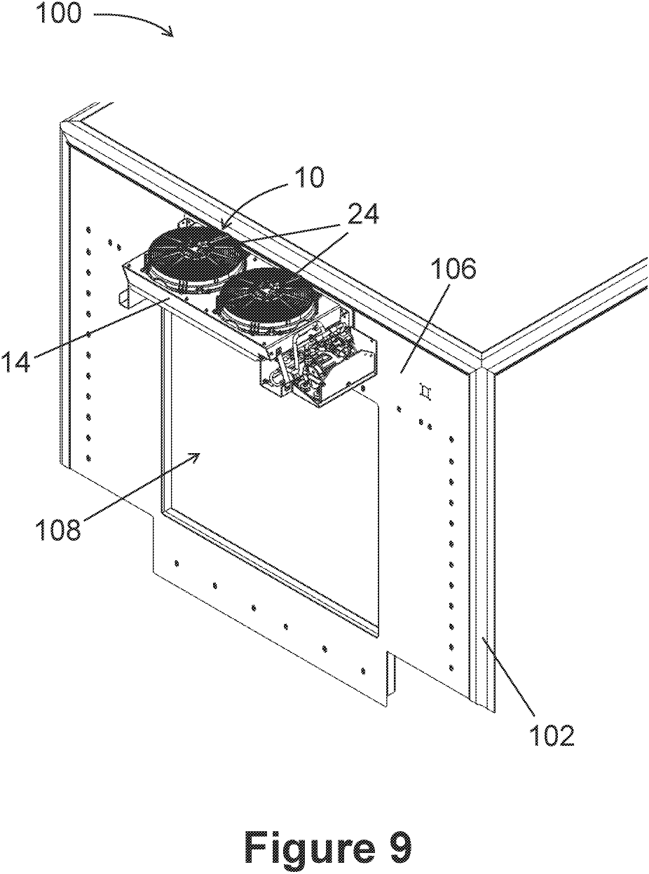

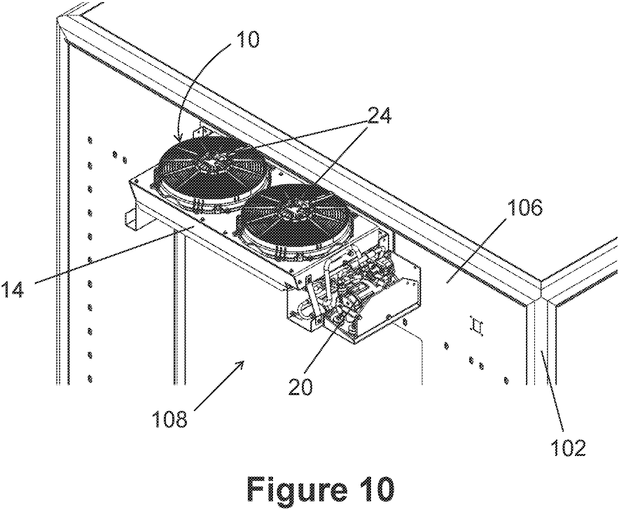

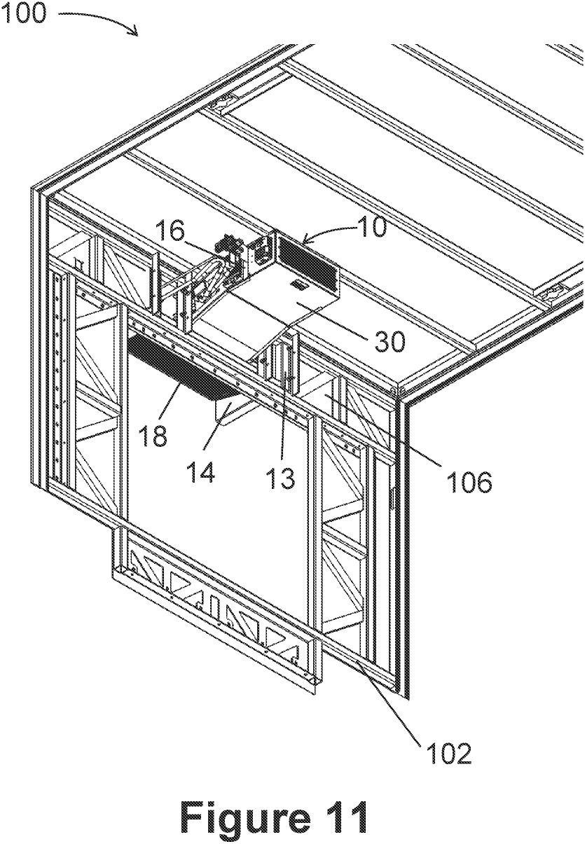

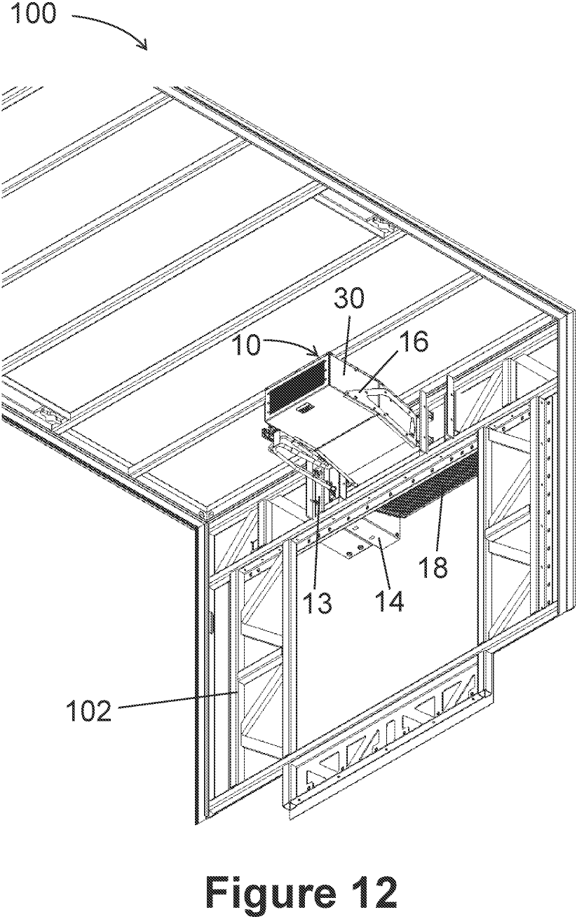

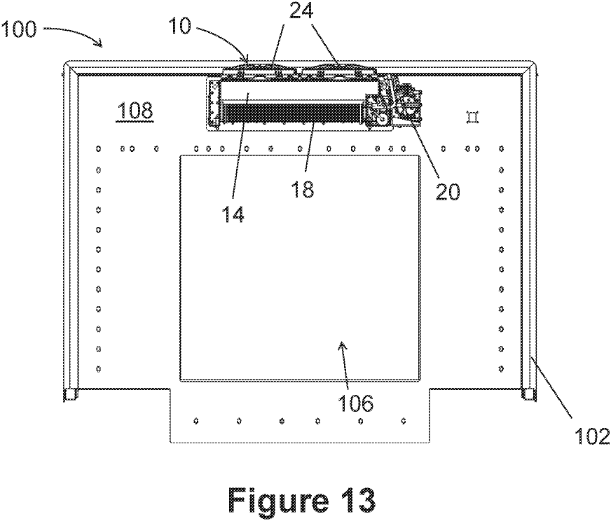

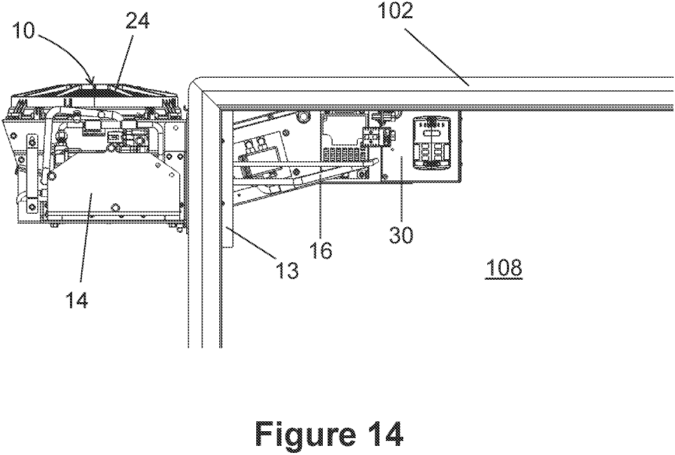

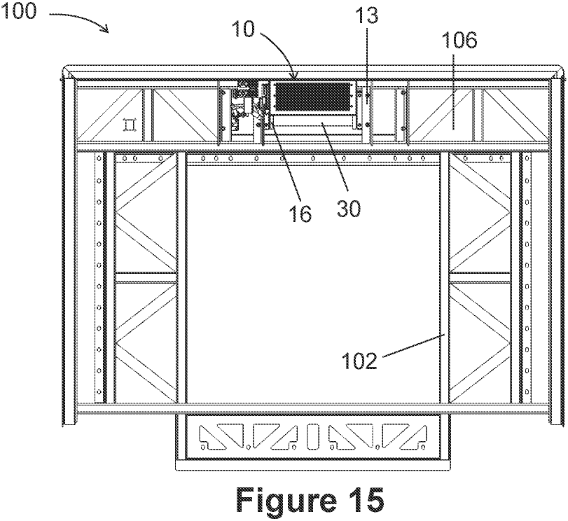

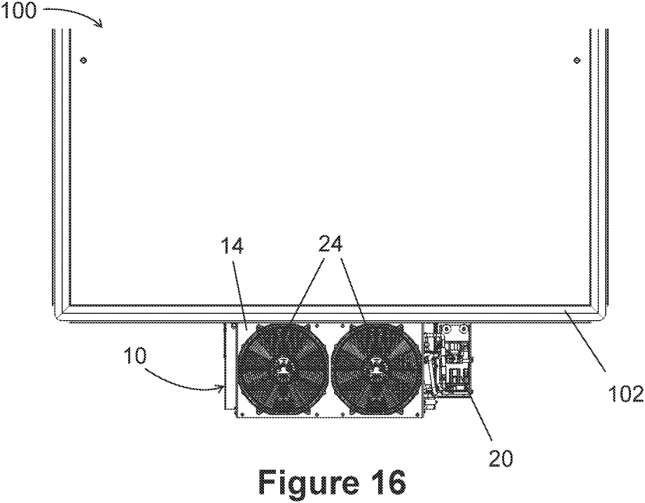

To address the above issues, an HVAC system in the form of a self-contained unit is, therefore, advantageous. The present disclosure, thus, relates to a single-unit HVAC system 10 and uses thereof. As best seen in FIGS. 1-7, the HVAC system 10 generally includes a frame 12, one or more manually releasable clamps 13, and HVAC components secured to the frame 12. The frame 12 is sized, shaped, and otherwise configured to be releasably coupled to a chassis 102 of a vehicle 100 (FIGS. 9-17 illustrate an example embodiment of the HVAC system 10 in use with the vehicle 100).

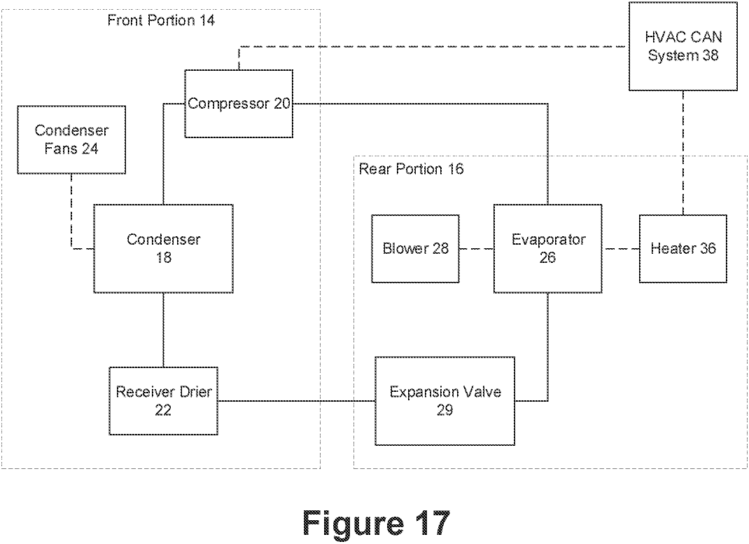

The frame 12 in the present disclosure of FIGS. 1-7 has a front portion 14 and a rear portion 16. The front portion 14 of the frame 12 is dimensioned and configured to support external HVAC system components, such as a condenser 18, a compressor 20, a receiver drier 22, and one or more condenser fans 24. The front portion 14 of the frame 12 is, thus, intended to be positioned outside the vehicle 100 in use. The opposed rear portion 16 of the frame is secured to, or extends from, the front portion 14 of the frame 12. The rear portion 16 is dimensioned and configured to support internal HVAC system components, such as an evaporator 26, a blower 28, and an expansion valve 29 (shown in schematic form in FIG. 17). The rear portion 16 of the frame 12 is, thus, intended to be positioned inside the vehicle 100 in use.

To assist in positioning during installation, the front portion 14 of the frame 12 may be larger than the rear portion 16 of the frame 12. In the depicted embodiment of FIGS. 1-7, for example, the front portion 14 is wider than the rear portion 16. In this manner, the size difference of the portions of the frame 12 may help to ensure foolproof positioning of the HVAC system 10 relative to the vehicle 100 during installation.

In some applications, the frame 12 may be designed to handle the fulcrum loads by using an A frame structure which is supported from the top of the frame. This may eliminate concerns of structural integrity of the vehicle wall and concerns regarding the weight of the HVAC system 10 towards the front of the forward fulcrum. In addition, in use, the weight of the rear section 16 helps to offset the forward weight by also pivoting rearward off the fulcrum.

The HVAC system 10 may further include a chassis module 34 that is adapted to be secured to the chassis 102 of the vehicle 100. The chassis module 34 may be another frame that provides structural integrity to an opening/hole in the wall of the vehicle 100. Thus, the chassis module 34 may assist in anchoring, or helping to couple, the frame 12 to the chassis 102 of the vehicle 100. To that end, the chassis module 34 may include a plate that is mounted to the exterior (in use) that includes a gasketed, sealing flange around the outside of the chassis module 34 to prevent water ingress into the vehicle 100.

In the depicted embodiment, the chassis module 34 and the frame 12 are coupled together. For example, they may be coupled together with rivets, glued together, welded together, bolted together, or some combination of those methods. In this manner, the entire HVAC system 10 may be set into the opening in the wall of the vehicle 100 and the chassis module 34 may then be bolted or clamped to the chassis 102 of the vehicle 100. In other applications, the chassis module 34 and the frame 12 may be provided separately before being coupled together and releasably secured to the vehicle 100.

The HVAC system 10 may further have one or more clamp style connectors, or manually releasable clamps 13, that function and are configured to releasably secure/hold the frame 12 (including all the HVAC components thereon) and the chassis module 34 to the chassis 102 of the vehicle 100. The manually releasable clamps 13 may be quick-release clamps that can be manually engaged and disengaged without the use of additional tools. In that regard, the manually releasable clamps 13 may be one of a wide variety of different mechanical clamping mechanisms that can be manually operated to releasably secure the chassis module 34, or both the frame 12 and the chassis module 34, to the chassis 102 of the vehicle 100. In some applications, the manually releasable clamps 13 may, initially, be coupled to the chassis module 34 (as depicted in FIGS. 1-7 for example) and/or the frame 12, or be separate from both the frame 12 and the chassis module 34 prior to securing the frame 12 and the chassis module 34 to the chassis 102 of the vehicle 100.

The embodiment shown in FIGS. 1 to 7 further includes an external enclosure or shell 30 that covers and protects internal components, such as the evaporator 26 and the blower 28. The frame 12, chassis module 34, and the external enclosure 30 may be made from a suitably strong material, such as powder-coated aluminum and/or galvanized steel, for reduced weight and corrosion reduction.

In typical split HVAC systems in a vehicle, condensate drains are located in the inside of the vehicle. In the present HVAC system 10, the condensate drains may be positioned at the front portion 14 of the frame 12. Thus, the condensate drains may be located externally when in use with the vehicle 100, thereby helping to eliminate the chances of leaks within the HVAC system 10 and the vehicle 100. In certain applications, internal or external condensate drains may be added or removed by installing or removing pipe plugs to/from the desired drain.

Because the HVAC system 10 is releasably securable to the chassis 102 of a vehicle 100, the HVAC system 10 further includes one or more electrical connectors 32 extending from the frame 12, the one or more electrical connectors 32 configured to electrically couple the HVAC system 10 to a battery (not shown) of the vehicle 100. While also not shown, the HVAC system 10 may further include one or more corresponding electrical connectors that are configured to be securable to, and/or extending from, the vehicle 100. In that manner, the one or more electrical connectors 32 may be releasably coupleable with the one or more corresponding electrical connectors to form one or more electrical connections, in order to bring the HVAC system 10 into electrical communication with the battery of the vehicle. To assist in the ease of installation of the HVAC system 10, the electrical connectors 32 and the corresponding electrical connectors may be quick-connect or poka-yoke electrical connections.

In some applications, the HVAC system 10 may be configured to operate at a high voltage range, such as from 12VDC to 806VDC. In some applications, the HVAC system 10 may be configured to operate from 400VDC to 850VDC. To that end, the current embodiment of the HVAC system 10 may have five quick-connect electrical connections, while other HVAC systems may have a different number of electrical connections.

Given the operational high voltage range, the HVAC system 10 may further have a high voltage interlock loop safety system. Such a system may help to ensure that if any electrical connector is disconnected in operation, the high voltage is shut off to eliminate electrocution of any users.

Turning to the HVAC components, the HVAC system 10 includes the condenser 18, the compressor 20, the receiver drier 22, and the condenser fans 24 (which may be secured to the front portion 14 of the frame 12), the evaporator 26, the blower 28, and the expansion valve 29 (which may be secured to the rear portion 16 of the same frame 12).

In some applications, the condenser 18 may comprise a dual pass multiflow condenser coil, the receiver drier 22 may be a horizontal receive drier, the evaporator 26 may be a 7 row copper tube and fin evaporator, the expansion valve 29 may be a 2 ton thermal expansion valve, and the blower may be a brushless blower. In other applications, different types of the condenser 18, the receiver drier 22, the evaporator 26, the blower 28, and the expansion valve 29 may be used.

The HVAC system 10 may also have an actuator controlled condenser air louver that is configured to reduce drag while vehicle is in motion and to allow additional air in when vehicle is stationary.

In the particular embodiment depicted in FIGS. 1 to 7, the HVAC system 10 also includes two condenser fans 24, such as two brushless 15″ fans. In other applications, a different number of condenser fans may be used, such as one large condenser fan. The condenser 18, the compressor 20, the evaporator 26, and the expansion valve 29 are operatively coupled together in fluid communication and adjacent to one another within the frame 12, while the condenser fans 24 are in operational engagement with the condenser 18 within the frame 12.

Typically, HVAC systems installed in existing vehicles are split systems, where the evaporator and the condenser assemblies are installed independently from one another, thereby requiring external hoses to run between them. The compressor is also usually independently secured to the vehicle, often coupled to be driven by the engine, thereby also requiring external hoses to connect it to the rest of the HVAC system. Such external hoses provide room for error in installation and may be vulnerable to damage over time. The present HVAC system 10 addresses such issues as all of the HVAC components are contained within a single-unit HVAC system 10 to provide both cooling and heating functions. In that manner, the HVAC system 10 is self-contained.

The HVAC system 10 further includes motors operating the blower 28, the compressor 20, and the one or more condenser fans 24, where the motors may be brushless motors. For example, the brushless motors may be pulse width modulation (PWM) controlled brushless motors with a 40,000 Hr service rating to help provide longevity and flexible control to maximize the energy consumption.

Given its use on a vehicle, the compressor 20 may be iso-mounted to the front portion 14 of the frame 12 with anti-vibration mounts, and rubber hoses may be used to couple the compressor 20 to the condenser 18 and the evaporator 26, to help reduce vibrations. As well, while the compressor 20 may be a reciprocating compressor, other types of compressors may be used, including a scroll compressor. For example, the compressor 20 may be an 800 V, 34 CC scroll style compressor with speeds from 1000 RPM to 8500 RPM. Such a compressor may provide around 8.5 kW of cooling and may be managed by a main HVAC controller.

To that end, the compressor 20 may have a controller area network (CAN) connector to link the compressor 20 to an HVAC CAN system 38. Thus, the compressor 20 may be CAN controlled when in use.

The HVAC system 10 may further include a heater 36, such as a positive temperature coefficient (PTC) heater, or more specifically a 3500 w PTC heater. The use of PTC technology allows for exceptional heat production (such as 3.5 kW of heating) and transfer with self-regulating technology. Optionally, the present HVAC system 10 may also or alternatively use a heat pump design and/or integrated coolant style heating to further increase heating capacity. The PTC heater may be controlled by a High Voltage PTC controller that may also be coupled to the HVAC CAN system 38. The PTC controller may use solid-state components to fluctuate the voltage by PWM control of the high voltage to the heater to provide 0-100% control of heating. The PTC controller may also be coupled to a temperature sensor (not shown) to measure the temperature of the heater 36 and an airflow sensor (not shown) to ensure that the blower 28 is operating, ensuring that the heater 36 does not get too hot.

In further applications, the HVAC system 10 may also include air filters and air filtration options with particular MPR and MERV ratings.

As noted above, the HVAC components in the present HVAC system 10 are contained within a single-unit HVAC system 10 to provide both cooling and heating functions. In that manner, the HVAC system 10 is self-contained.

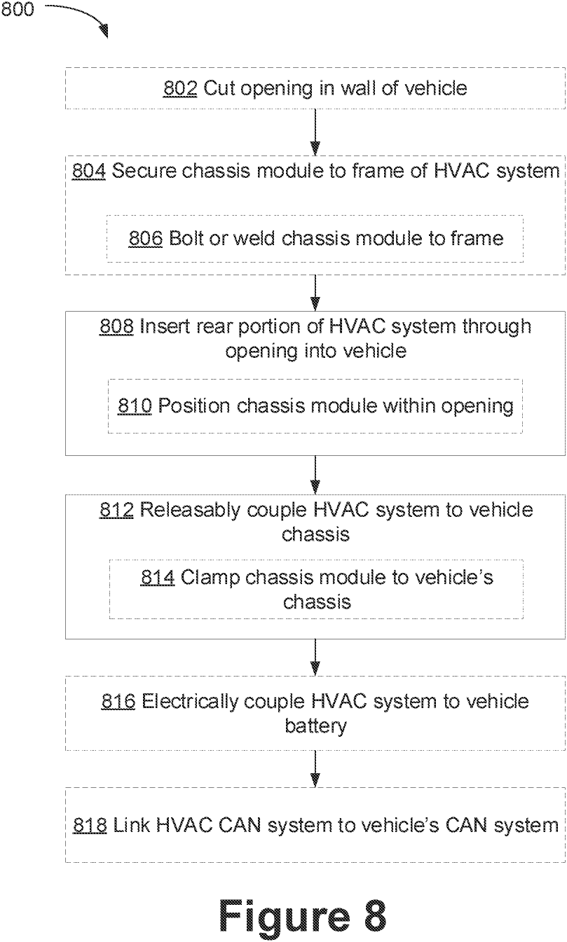

FIG. 8 illustrates an example method 800 in which the self-contained HVAC system 10 of FIGS. 1-7 may be installed into the vehicle 100. While the HVAC system 10 is used to described the method 800, other similar HVAC systems may alternatively be used to perform the method 800. The vehicle 100 may be a large vehicle, such as a commercial truck, a campervan, a bus, a food truck, a delivery truck, or a recreational vehicle etc., and the vehicle 100 may be electric.

At 802, if not already in place, an opening or hole may be cut into the wall of the vehicle 100. The opening is preferably positioned proximate to a portion of the chassis 102 of the vehicle 100, and is shaped and sized to receive at least a portion, such as the rear portion 16, of the HVAC system 10 therethrough. In some applications, the opening may be a 36.5” × 11.5” rectangle. The opening may have a different shape or size depending on the shape and size of the rear portion 16 of the HVAC system 10. Notably, the opening is not large enough for the front portion 14 of the frame 12 to fit through, thus assisting in their relative positioning during installation. Alternatively, the wall of the vehicle 100 may be fabricated or pre-formed with the appropriate sized opening already in place.

At 804, if not already coupled together, the chassis module 34 may be secured to the frame 12 of the HVAC system 10. Optionally at 806, the chassis module 34 may be coupled with rivets, glued, bolted, or welded to the frame 12 of the HVAC system 10. As noted above, the chassis module 34 may be configured to provide structural integrity to the opening in the wall of the vehicle 100 and, thus, help to couple the frame 12 to the chassis 102 of the vehicle 100.

At 808, the rear portion 16 of the HVAC system 10 may be inserted through the opening in the wall of the vehicle 100. To assist with this, the HVAC system 10 may include lifting points at its center of gravity so the HVAC system 10 can be slid into the opening in the wall of the vehicle 100. As noted above, the opening in the wall is not large enough for the front portion 14 of the frame 12 to fit through, thus assisting in ensuring that the front portion 14 does not also get inserted into the vehicle 100 during installation. Thus, optionally at 810, the chassis module 34 may be positioned within the opening in the wall of the vehicle 100.

Then at 812, the HVAC system 10 may be releasably coupled to the chassis 102 of the vehicle 100, such as by releasably securing the chassis module 34 and/or the frame 12 to the chassis 102 of the vehicle 100. In some applications, the chassis module 34 may be clamped or bolted to the chassis 102 of the vehicle 100. In such applications, the HVAC system 10 may have one or more clamp style connectors, or manually releasable clamps 13. Optionally at 814 then, the chassis module 34 (and/or the frame 12) of the HVAC system 10 may be clamped onto the chassis 102 to releasably secure or hold the HVAC system 10 to the chassis 102 of the vehicle 100. The use of quick-release clamps allow the HVAC system 10 to be releasably secured to the chassis 102 manually without the use of additional tools.

At 816, the HVAC system 10 may be electrically coupled to the battery of the vehicle 100. To that end, the HVAC system 10 may have electrical connectors 32 and corresponding electrical connectors that collectively form quick-connect or poka-yoke electrical connections. Thus, the electrical connectors may simply have to be coupled together to bring the HVAC system 10 into electrical connection with the battery of the vehicle.

At 818, for operational purposes, the HVAC controller area network (CAN) system 38 of the HVAC system 10 may further be linked to the vehicle’s CAN system.

The modular and quick-release nature of the present HVAC system 10 allows the entire HVAC system 10 to be removed from, or inserted into, the vehicle 100 in minutes. This allows the HVAC system 10 in each vehicle 100 to be replaced with a new unit quickly for service and maintenance, and easing the process for technicians. This helps to reduce downtime and makes it easy to repair the HVAC system 10 when necessary. To that end, a user may keep a spare unit so they can remove and replace the HVAC system 10 from the vehicle. In the case of electric vehicles, they are often notably more expensive than their fossil fuel counterparts are. Therefore, other advantages of the present HVAC system 10 include its longevity, ease of service, and reduction of emission of refrigerants.

FIGS. 9-17 illustrates an example of the HVAC system 10 after installation into a vehicle 100 using the method 800. The HVAC system 10 is shown to be secured to the chassis 102 through a wall 106 of the vehicle 100. The vehicle 100 may be a large vehicle, such as a commercial truck, a campervan, a bus, a food truck, an ambulance, a delivery truck, or a recreational vehicle etc., and the vehicle may be an electric vehicle. In the particular embodiment depicted in FIGS. 9-17, the vehicle 100 is an electric vehicle and an ambulance with a patient compartment 108.

After installation is complete, the front portion 14 of the frame 12, and the HVAC components thereon, are positioned outside the vehicle 100 in use, while the rear portion 16 of the frame 12, and the HVAC components thereon, are positioned inside the vehicle 100 in use. The HVAC system 10 may be electrically coupled to the battery of the electric ambulance, and the HVAC CAN system 38 may be further linked to the vehicle’s CAN system.

One advantage of the present HVAC system 10 when used with an electric vehicle, is that it has the ability to provide maximum cooling even when the electric vehicle is sitting still. When traditional engine vehicles idle, that means the compressor is operating at a lower RPM, which reduces the air conditioning capacity. In contrast, the present HVAC system 10 can provide full performance whenever it is needed and the performance can be scaled back to reduce energy when that is needed. If the battery is low or needs to be maximized to extend the vehicle’s range, this can be controlled and managed through the HVAC CAN system 38.

In some applications, the HVAC CAN system 38 may be a dual CAN channel system. The dual CAN channel system is a CAN system where one network acts as a slave, which allows the HVAC CAN system 38 to communicate information that is collected elsewhere on the vehicle 100, including temperature set points, temperature sensors, door position sensors and other control messages. It also provides communications back to the HVAC CAN system 38 for system status and trouble messages. The second channel of the dual CAN channel system acts as the master, where the controller will communicate to other devices connected in the HVAC CAN system 38, such as additional PTC controllers, GSM devices and Bluetooth devices etc.

The dual CAN channel system may have 12 Inputs and 12 Outputs. The Inputs may include information from a Low Pressure Transducer, a High Pressure Transducer, an Electronic Thermostat, a Return Air Temp Sensor, an Outside Air Temperature sensor, and Actuator Feedback as necessary. Outputs may include information relating to Condenser Fans PWM, Blower PWM, Compressor PWM, and Actuators as necessary for options.

The HVAC system 10 may also have a Bluetooth option, which has the capability of connecting with a smart phone via Bluetooth. Access can be given for control functions as well as system status and error codes. In that manner, the user will not need to connect gauges to troubleshoot the HVAC system 10. The HVAC system 10 may also have GSM capabilities, it may be connected to a 4G network for remote diagnosis, and data and software updates.

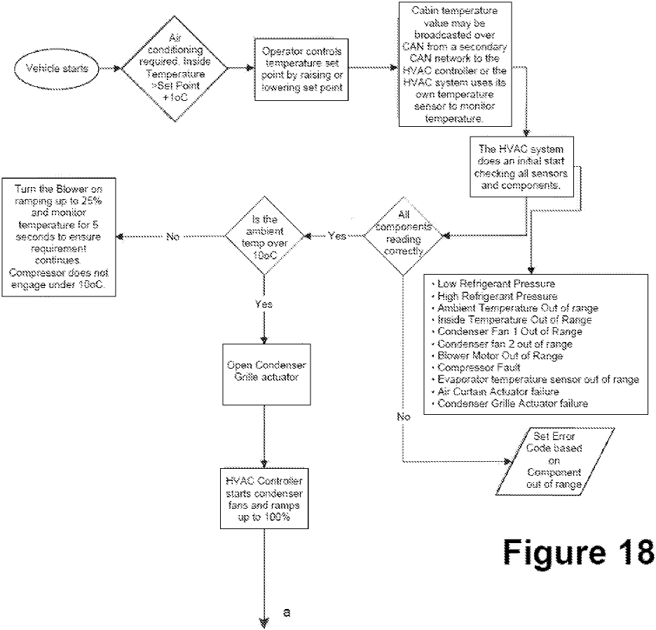

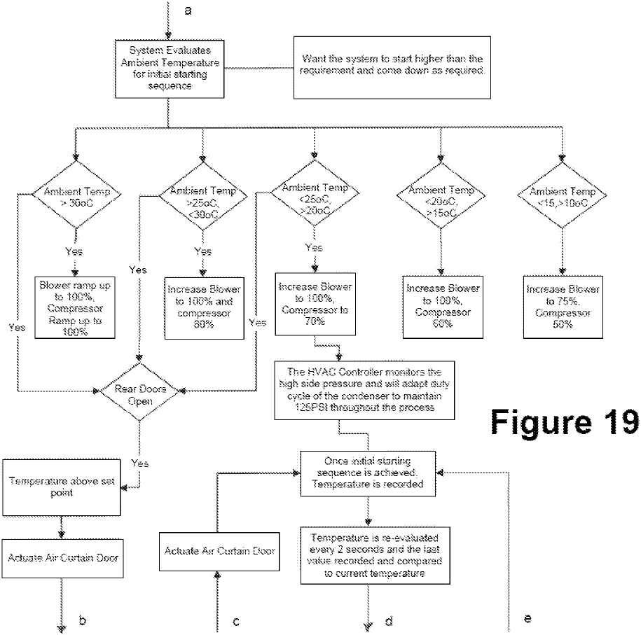

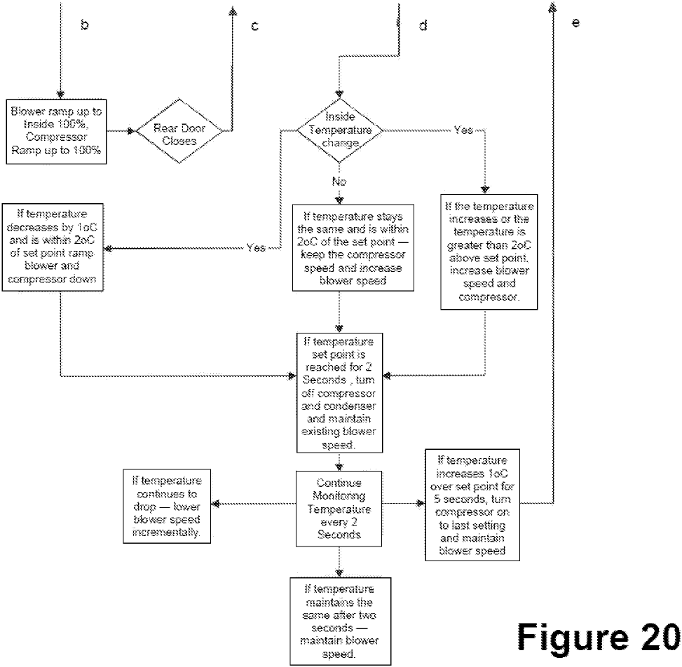

The HVAC CAN system 38 may also allow for more nuanced operational control of the HVAC system 10. FIGS. 18, 19, and 20 illustrate a flow chart detailing operational parameters and CAN control of the HVAC system 10.

Through the HVAC CAN system 38, the HVAC system 10 may relay diagnostic information and trouble codes to the vehicle’s CAN system. By connecting via Bluetooth, the HVAC system 10 can provide system status and data.

The HVAC system 10 may have energy control logic to maximize its energy consumption. For example, the software of the HVAC system 10 may be designed to maximize the efficiency of the HVAC system 10 based on the compressor’s workload versus the condenser fan speed. Based on the high side pressure measurements, the load may be calculated in the software and effort may then be made to reduce the pressure by increasing the condenser fan speed and, therefore, improving the coefficient of performance.

The HVAC system 10 may further have software that uses pressure sensors to monitor for high- and low-pressure. By measuring the high and low side pressures, the software can utilize this information to make the HVAC system 10 more efficient, and this data may be made available to technicians for ease of troubleshooting.

In contrast to a standard engine drive system, full capacity of the HVAC system 10 can be achieved at any time depending on the electrical capacity of the system. This permits better performance at peak times, such as when doors are open etc. An advantage of the HVAC system 10 being self-contained is that it will typically reduce overall refrigerant requirements, which can be positive for the environment should a leak occur. The HVAC system 10 may also be fully controlled electrically by using the HVAC CAN system 38. This would allow more accurate control of the HVAC system 10 so as to use as little energy as possible, yet provide peak performance when it is needed. Use of the HVAC CAN system 38 also helps to reduce wiring in the HVAC system 10, thereby also requiring less raw materials. It will be appreciated by the skilled person that an AC system is easily influenced by external factors, such as doors opening, which can have a significant impact on the energy required and on the overall internal vehicle temperature. The use of the dual CAN channel system in communication with temperature and pressure sensors can provide vital information that may be used to control the fans, blower, and compressor, for optimum performance and energy usage. The central remote monitor/control can be used to both provide information, and to receive information, from the vehicle’s HVAC controller.

For example, when the HVAC system 10 detects that doors of the vehicle are opened, the system can go into a high blower/high capacity mode and the actuator at the end of the air outlet that faces the relevant door will open to allow most of the internal cool air out, thereby creating a curtain of cool air.

Other advantages of the above described systems and methods include:

1. Complete assembly can be quality checked before delivery
a. Nitrogen tested for leaks
b. Vacuum tested for leaks
c. Electrically Tested
d. Operation tested

2. No refrigerant charging at vehicle assembly — reduces time to pressure test, fill system and no risk of leaks having to be solved on the production line.

3. No Hose installation required on the vehicle assembly line. Hose crimps can be done using a hose assembly machine with better quality than using clip style fittings.

4. System components matched to provide consistent results. This provides predictability in the field. The space to cool is nearly the same every time therefore it reduces the variety of variations.

5. Reduces the amount of refrigerant — easier to meet J2727 standard with less connections and hose lengths.

It is to be understood that what has been described are the preferred embodiments of the invention. The scope of the claims should not be limited by the preferred embodiments set forth above, but should be given the broadest interpretation consistent with the description as a whole.

1. An HVAC system for operation with a vehicle, the HVAC system comprising:
a frame having a front portion and a rear portion;
one or more manually releasable clamps configured to releasably couple the frame to a chassis of the vehicle; and
system components secured to the frame, the system components comprising:
an evaporator and a blower secured to the rear portion of the frame;
a condenser, a compressor, and a receiver drier are secured to the front portion of the frame, wherein the condenser, the compressor, and the evaporator are operatively coupled together in fluid communication; and
one or more condenser fans secured to the front portion of the frame in operational engagement with the condenser.

2. The HVAC system of claim 1, wherein the front portion of the frame is wider than the rear portion of the frame.

3. The HVAC system of claim 2, further comprising a chassis module secured to the frame, the chassis module further adapted to be securable to the chassis of the vehicle; the one or more manually releasable clamps configured to releasably secure the chassis module to the chassis of the vehicle.

4. The HVAC system of claim 3, further comprising one or more electrical connectors extending from the frame, the one or more electrical connectors configured to electrically couple the HVAC system to a battery of the vehicle.

5. The HVAC system of claim 4, comprising five electrical connectors extending from the frame.

6. The HVAC system of claim 1, further comprising an HVAC controller area network (CAN) system, wherein the compressor comprises a CAN connector to link the compressor to the HVAC CAN system.

7. The HVAC system of claim 6, further comprising a positive temperature coefficient (PTC) heater.

8. The HVAC system of claim 7, wherein the PTC heater is configured to be linked to the HVAC CAN system.

9. The HVAC system of claim 6, wherein the HVAC CAN system is a dual CAN channel system.

10. The HVAC system of claim 1, wherein the compressor is secured to the front portion of the frame with anti-vibration mounts.

11. The HVAC system of claim 1, wherein the compressor is a scroll compressor.

12. The HVAC system of claim 4, wherein the vehicle is an electric vehicle.

13. The HVAC system of claim 4, wherein the vehicle is an ambulance.

14. A method of installing a single-unit HVAC system to a vehicle comprising:
inserting a rear portion of the single-unit HVAC system through an opening in a wall of the vehicle; and
releasably coupling the single-unit HVAC system to a chassis of the vehicle.

15. The method of claim 14, further comprising:
securing a chassis module to a frame of the single-unit HVAC system;
wherein releasably coupling the single-unit HVAC system to the chassis of the vehicle comprises releasably securing the chassis module to the chassis of the vehicle.

16. The method of claim 15, wherein releasably securing the chassis module to the chassis of the vehicle comprises manually and releasably clamping the chassis module to the chassis of the vehicle.

17. The method of claim 16, further comprising cutting the opening in the wall of the vehicle.

18. The method of claim 17, further comprising electrically coupling the single-unit HVAC system to a battery of the vehicle.

19. The method of claim 18, further comprising linking a controller area network (CAN) system of the single-unit HVAC system to a controller area network (CAN) system of the vehicle.

20. An HVAC system for operation with an electric vehicle, the HVAC system comprising:
a frame having a front portion and a rear portion, where the front portion is wider than the rear portion;
a chassis module secured to the frame, the chassis module adapted to be secured to a chassis of the electric vehicle;
one or more manually releasable clamps configured to releasably secure the chassis module to the chassis of the electric vehicle; and
system components secured to the frame, the system components comprising:
an evaporator, a blower, and a heater secured to the rear portion of the frame;
a condenser, a compressor, and a receiver drier are secured to the front portion of the frame, wherein the condenser, the compressor, and the evaporator are operatively coupled together in fluid communication; and
one or more condenser fans secured to the front portion of the frame in operational engagement with the condenser;
wherein the electric vehicle is an ambulance.
